(19) United States
(12) Patent Application Publication
(10) Pub. No.: US 2023/0110816 A1
(43) Pub. Date: Apr. 13, 2023

(54) POWER SUPPLY DEVICE AND VEHICLE

(71) Applicant: TOYOTA JIDOSHA KABUSHIKI KAISHA, Toyota-shi Aichi-ken (JP)

(72) Inventors: Zixun MEI, Edogawa-ku Tokyo-to (JP); Takashi NISHIMURA, Chofu-shi Toyo-to (JP); Hiroya FUKUOKA, Kariya-shi Aichi-ken (JP)

(73) Assignee: TOYOTA JIDOSHA KABUSHIKI KAISHA, Toyota-shi Aichi-ken (JP)

(21) Appl. No.: 17/959,765

(22) Filed: Oct. 4, 2022

(30) Foreign Application Priority Data
Oct. 8, 2021 (JP) 2021-166466

(51) Int. Cl. H01M 8/04082; H01M 8/04089; H01M 8/02; B60L 50/71

(52) U.S. Cl. CPC H01M 8/04201; H01M 8/04089; H01M 8/02; B60L 50/71; H01M 2250/20

(57) ABSTRACT

A power supply device includes: a main body configured mountable to a roof of a vehicle; a tank insertion hole formed in the main body for detachable insertion of a hydrogen tank; a fuel cell stack provided inside the main body and configured to generate electricity by being supplied with hydrogen from the hydrogen tank attached to the main body; and an output section provided on an outer face of the main body to output power generated by the fuel cell stack.

### CROSS-REFERENCE TO RELATED APPLICATION

This application is based on and claims priority under 35 USC 119 from Japanese Patent Application No. 2021-166466 filed on Oct. 8, 2021, the disclosure of which is incorporated by reference herein.

### BACKGROUND

### Technical Field

The present disclosure relates to a power supply device and a vehicle.

### Related Art

Japanese Patent Application Laid-Open (JP-A) No. 2009-270707 discloses a vehicular hydrogen storage device able to be easily attached to a vehicle equipped with a fuel cell system, or detached therefrom. More specifically, the vehicular hydrogen storage device of JP-A No. 2009-270707 is configured including plural hydrogen tanks, a case to house these hydrogen tanks, a regulator, and a quick connector for attaching or detaching the hydrogen tanks to a fuel cell system.

However, the vehicular hydrogen storage device described in the above publication is only able to be applied to a fuel cell vehicle installed with a fuel cell stack, and so there is room for improvement in widening the utilization of hydrogen energy.

### SUMMARY

In consideration of the above circumstances, the present disclosure provides a power supply device and vehicle capable of utilizing hydrogen energy even in a vehicle that is not a fuel cell vehicle.

A first aspect of the present disclosure is a power supply device including a main body configured mountable to a roof of a vehicle, a tank insertion hole formed in the main body for detachable insertion of a hydrogen tank, a fuel cell stack provided inside the main body and configured to generate electricity by being supplied with hydrogen from the hydrogen tank attached to the main body, and an output section provided on an outer face of the main body to output power generated by the fuel cell stack.

The first aspect includes the main body mountable to the roof of a vehicle, with the tank insertion hole formed in the main body. A hydrogen tank is able to be inserted into the tank insertion hole in a attachable-detachable manner. The fuel cell stack is provided inside the main body, and the fuel cell stack generates electricity by being supplied with hydrogen from the hydrogen tank fitted to the main body. An output section is also provided on the outer face of the main body for outputting power generated by the fuel cell stack. This enables power generated from hydrogen filled in the hydrogen tank to be utilized even in a vehicle not equipped with a fuel cell stack.

Moreover, due to the output section being provided on an outer face of the main body, an electrical device may be used outside the vehicle simply by connecting the cord of the electrical device to the output section. Furthermore, due to the hydrogen tank being attachable to, and detachable from, the main body, power supply may be performed by merely exchanging hydrogen tanks.

In the first aspect, plural tank insertion holes may be formed in the main body.

The above configuration enables plural hydrogen tanks to be fitted to the main body. This enables more power to be supplied without exchanging hydrogen tanks than in a structure for fitting one hydrogen tank alone.

In the first aspect the tank insertion hole may open at a front section of the main body.

Styling limitations are not imposed on the side and rear portions of the main body by the tank insertion hole in the above configuration due to the tank insertion hole opening in the front section of the main body. This accordingly enables styling characteristics to be raised when viewed from the vehicle sides and rear.

In the first aspect, the fuel cell stack may be configured so as to enable power to be supplied to a battery installed to the vehicle.

It is possible to extend the cruising range in the vehicle that has a motor as a drive source in the above configuration due to power being supplied from the fuel cell stack to the battery.

A second aspect of the present disclosure is a vehicle including a vehicle body, a carrier provided on a roof of the vehicle body, and the power supply device of the first aspect, fixed to the carrier.

In the vehicle according to the second aspect, the carrier is provided on the roof of the vehicle body and the power supply device is fixed to the carrier. This enables power to be supplied to both inside and outside of the vehicle from the power supply device.

As explained above, the power supply device and the vehicle according to the present disclosure enable hydrogen energy to be utilized even in a vehicle that is not a fuel cell vehicle.

### BRIEF DESCRIPTION OF THE DRAWINGS

FIG. 1 is a schematic side view of a vehicle installed with a power supply device according to an exemplary embodiment.

FIG. 2 is a schematic perspective view of a power supply device according to an exemplary embodiment, illustrated in a state in which hydrogen tanks have been removed.

FIG. 3 is a schematic perspective view illustrating a state in which hydrogen tanks have been fitted from the state of FIG. 2.

### DETAILED DESCRIPTION

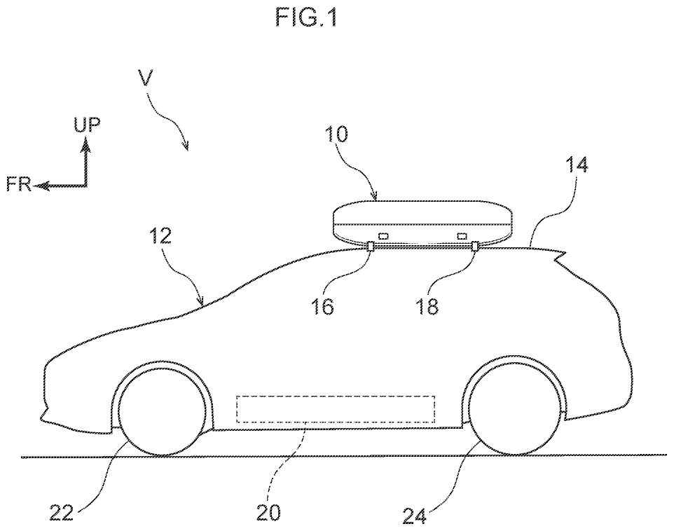

Description follows regarding a power supply device 10 according to an exemplary embodiment, with reference to the drawings. Note that arrow FR and arrow UP in FIG. 1 indicate forward in a vehicle front-rear direction and upward in a vehicle vertical direction of a vehicle V installed with the power supply device 10. In the following description, unless stated otherwise reference simply to front-rear, up-down, and left-right directions indicate front-rear in the vehicle front-rear direction, up-down in the vehicle vertical direction, and left-right in the vehicle width direction in a mounted installed state of the power supply device 10 to the vehicle V.

As illustrated in FIG. 1, the vehicle V includes a vehicle body 12, and a battery 20 is installed in the vehicle body 12. Electric power is accumulated in the battery 20 for supply to a non-illustrated motor serving as a motive power source to drive the vehicle V. Front wheels 22 or rear wheels 24 or both sets of wheels are rotated by suppling power from the battery 20 to the motor, causing the vehicle V to travel. Namely, the vehicle V of the exemplary embodiment is, for example, a battery electric vehicle (BEV). Note that the vehicle body 12 has the same structure as that of an ordinary electric vehicle and so detailed description of the vehicle body 12 will be omitted. Seats including a driving seat and a front passenger seat are provided in the vehicle body 12, and the battery 20 is arranged below the floor of a vehicle cabin.

Carrier bars 16, 18 of a carrier are provided on a roof 14 of the vehicle body 12. The carrier bar 16 is provided at a front section of the roof 14, and the carrier bar 18 is provided at a rear section of the roof 14.

The carrier bar 16 and the carrier bar 18 are elongated shaped member that extend along the vehicle width direction, and portions at both vehicle width direction ends of the carrier bar 16 and the carrier bar 18 are attached to roof rails. The power supply device 10 is fixed on top of the carrier bars 16, 18.

Power Supply Device 10

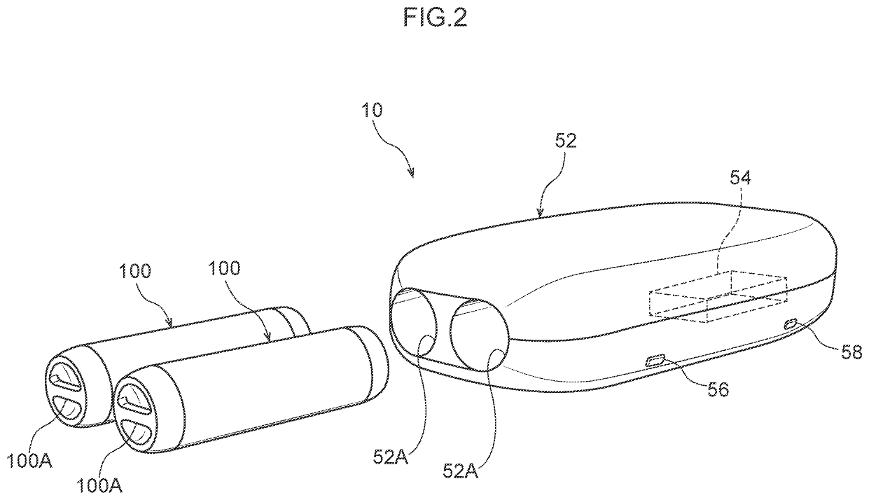

As illustrated in FIG. 2, the power supply device 10 of the exemplary embodiment is configured including a main body 52, a fuel cell stack 54, and output sections 56, 58.

The main body 52 is formed with a flat, substantially cuboidal shape, with a length direction along the vehicle front-rear direction when in a state fixed to the vehicle V. Non-illustrated engagement portions are formed to a bottom face of the main body 52, in a structure in which the main body 52 is mounted to the roof 14 by the engagement portions engaging with the carrier bars 16, 18.

Two tank insertion holes 52A are formed in a front section of the main body 52. The tank insertion holes 52A are formed side-by-side in the vehicle width direction, and openings are formed in front portions of the main body 52. The two tank insertion holes 52A each extend inside the main body 52 along the vehicle front-rear direction, and each is shaped to enable insertion of the hydrogen tank 100.

The hydrogen tanks 100 for insertion into the tank insertion holes 52A are each formed in a substantially cylindrical shape with a smaller diameter than the tank insertion holes 52A, and are filled with hydrogen. A handle 100A for gripping by a user is provided at one axial direction end portion of each of the hydrogen tanks 100, enabling the hydrogen tank 100 to be easily carried by gripping the handle 100A.

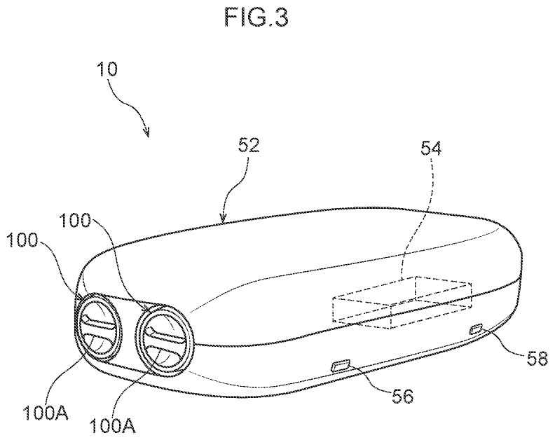

The hydrogen tanks 100 are each inserted into the tank insertion hole 52A from the other axial direction end of the hydrogen tank 100 on the opposite side to the handle 100A. The end face on the one axial direction end of the hydrogen tank 100 is in a substantially flush state with the front face of the main body 52 in a state in which the hydrogen tank 100 has been inserted into the tank insertion holes 52A (see FIG. 3).

A non-illustrated indentation is formed in the circumferential face of the hydrogen tank 100, and the hydrogen tank 100 may be placed in a locked state inserted into the main body 52 by a non-illustrated lock pin provided inside the main body 52 engaging with this indentation. For example, a structure may employed in which, after insertion of the hydrogen tank 100 is complete, movement of the hydrogen tank 100 is latched (i.e., locked) by operating a non-illustrated operation button provided to an outer face of the main body 52, so as to project the lock pin out to engage with the indentation of the hydrogen tank 100. Moreover, for example, a structure may be adopted in which, after insertion of the hydrogen tank 100 is complete, the lock pin provided to the main body 52 is engaged with the indentation provided to the hydrogen tank 100 by gripping the handle 100A and rotating it by a specific angle in a specific direction. The hydrogen tank 100 is able to be removed from the main body 52 by releasing the engaged state between the lock pin and the indentation. The hydrogen tank 100 is accordingly inserted into the tank insertion hole 52A so as to be attachable and detachable in this manner.

A non-illustrated connector is provided to the other axial direction end of each of the hydrogen tanks 100, and connection fittings for connecting to the connectors of the hydrogen tanks 100 are provided to the main body 52. The connection fittings of the main body 52 are connected to the connectors of the hydrogen tanks 100 in a state in which the hydrogen tanks 100 have been locked into the main body 52, in a configuration such that the hydrogen filled in each of the hydrogen tanks 100 passes out from the connection portion, passes through non-illustrated pipes laid inside the main body 52, and flows into the fuel cell stack 54.

The fuel cell stack 54 is provided inside the main body 52. The fuel cell stack 54 is equipped with plural cells, and an electrolytic membrane is interposed between the positive electrode (i.e., anode, or fuel electrode) and the negative electrode (i.e., cathode, or air electrode) of each of the cells. An electrochemical reaction occurs due to the hydrogen flowing between the positive electrode of the cell and a separator on the positive electrode side, and air containing oxygen flowing between the negative electrode of the cell and a separator on the negative electrode side, with electrical energy being generated thereby (i.e., electricity generated).

The output sections 56, 58 are provided on an outer face of the main body 52 for outputting the power generated by the fuel cell stack 54. There are two of the output sections 56, 58 provided on the left face of the main body 52, and a cord of an electrical device may be connected to each of the output sections 56, 58. The output sections 56, 58 are each, for example, an electric socket or universal serial bus (USB) connector, configured so as to enable an electrical device cord to be connected by removing a cover of the output section 56, 58. The output section 56 on the front side and the output section 58 on the rear side may be plug-in ports built to different standards.

In the exemplary embodiment the fuel cell stack 54 and the battery 20 installed in the vehicle V are connected together electrically, so as to enable power from the fuel cell stack 54 to be supplied to the battery 20. For example, an end of a wire connected to the battery 20 may be connected to a non-illustrated connector provided to the roof 14, so as to connect the fuel cell stack 54 and the battery 20 together electrically by connecting a cord extending from the main body 52 of the power supply device 10 to this connector.

Operation and Effect

Next, description follows regarding the operation and effects of the exemplary embodiment.

The power supply device 10 of the exemplary embodiment includes the main body 52 mountable to the roof 14 of the vehicle V, with the tank insertion holes 52A formed in the main body 52. The fuel cell stack 54 is provided inside the main body 52, and the fuel cell stack 54 generates electricity by being supplied with hydrogen from the hydrogen tanks 100 attached to the main body 52. Moreover, the output sections 56, 58 are provided on an outer face of the main body 52 to output the power generated by the fuel cell stack 54. This accordingly enables the electric power obtained from the hydrogen filled in the hydrogen tanks 100 to be utilized even in a vehicle not equipped with a fuel cell stack.

Moreover, due to the output sections 56, 58 being provided on the outer face of the main body 52, electrical devices may be used outside the vehicle V by simply connecting cords of the electrical devices to the output sections 56, 58. Due to the hydrogen tanks 100 being attachable to the main body 52, and detachable therefrom, power supply may be performed merely by exchanging hydrogen tanks.

Moreover, in the exemplary embodiment plural of the hydrogen tanks 100 may be attached to the main body 52. This enables more power to be generated without exchanging the hydrogen tanks 100 than in a structure for attaching one hydrogen tank 100 alone.

Furthermore, due to the tank insertion holes 52A opening at front portions of the main body 52 in the exemplary embodiment, styling limitations are not imposed on the side and rear portions of the main body 52 by the tank insertion holes 52A. This accordingly enables styling characteristics to be raised when viewed from the vehicle sides and rear. For example, by adopting an external appearance similar to that of an ordinary roof box, any odd feeling toward the power supply device 10 may be reduced. In particular, in the exemplary embodiment, as illustrated in FIG. 3, in a state in which the hydrogen tanks 100 are attached to the main body 52 of the power supply device 10, the one axial direction end face of each of the hydrogen tanks 100 is flush with the front face of the main body 52 in the power supply device 10. This means that the shape of the main body 52 is a shape with few indentations and projections, enabling even higher styling characteristics to be secured.

Furthermore in the exemplary embodiment, the cruising range may be extended in the vehicle V that has a motor as a drive source due to power being supplied from the fuel cell stack 54 to the battery 20.

Moreover, in the exemplary embodiment the carrier bars 16, 18 are provided on the roof 14 of the vehicle body 12, and the power supply device 10 is fixed to the carrier bars 16, 18. This enables electrical power from the power supply device 10 to be supplied to both inside and outside of the vehicle. The power supply device 10 may also be exchanged easily. The power supply device 10 may moreover be retrofitted easily to a vehicle not installed with the power supply device 10, simply by attaching the carrier bars 16, 18.

Although this concludes description of the power supply device 10 according to the exemplary embodiment, obviously various embodiments may be implemented within a range not departing from the spirit of the present disclosure. For example, although a simple appearance with the tank insertion holes 52A and the output sections 56, 58 provided on outer faces of the main body 52 is adopted in the exemplary embodiment described, there is no limitation thereto. For example, a display may be provided on an outer face of the main body 52 in a configuration to display various information on the display. In such cases, by merely looking at the display, a user may be able to ascertain how much power has been generated by the fuel cell stack 54, how much hydrogen remains in the hydrogen tanks 100, and the like.

Moreover, although in the exemplary embodiment the tank insertion holes 52A are provided to a front section of the main body 52, there is no limitation thereto. For example, a configuration may be adopted in which the tank insertion holes 52A are formed to a side face of the main body 52. In such cases a user would be able to attach and detach the hydrogen tanks 100 from a side of the vehicle V, enabling efficiency to be raised when exchanging the hydrogen tanks 100.

Furthermore, although the exemplary embodiment is structured with the fuel cell stack 54 provided inside the main body 52, a structure may be adopted in which a battery is also installed therein to accumulate the power generated.

Furthermore, although the exemplary embodiment is configured so as to enable a user to remove the hydrogen tanks 100 from the main body 52 themselves, there is no limitation thereto. For example, a structure may be adopted in which the hydrogen tanks 100 are only able to be exchanged at a special facility for handling the hydrogen tanks 100. Examples of such a facility include a gasoline stand, a dealer, and a maintenance workshop.

Moreover, although the exemplary embodiment employs the hydrogen tanks 100 having a cylindrical shape formed with the handles 100A, there is no limitation thereto, and the hydrogen tanks may be formed in another shape. Furthermore, although the exemplary embodiment is structured to enable the two hydrogen tanks 100 to be inserted side-by-side in the vehicle width direction, there is no limitation thereto, and a structure may be adopted in which the two hydrogen tanks 100 may be inserted side-by-side in the vehicle vertical direction.

Furthermore, although output sections 56, 58 of the exemplary embodiment described above are electric sockets or the like to which cords of electrical devices may be connected, there is no limitation thereto. The output sections may, for example, be configured to include a cord extending from the main body 52. In such cases a structure may be adopted in which a connector is provided at a distal end of the cord serving as the output section. Moreover, a structure may be adopted without any entry ports in the output section by utilizing a contactless charging method.

Furthermore, although in the exemplary embodiment described above the power supply device 10 is installed to a vehicle V that is a battery electric vehicle (BEV), there is no limitation thereto. For example, the power supply device 10 may be installed to a hybrid electric vehicle (HEV) employing both an engine and a motor as drive sources, or the power supply device 10 may be installed to a fuel cell electric vehicle (FCEV). Moreover, the power supply device 10 may also be installed to a gasoline vehicle having an engine as a drive source and not equipped with a battery 20. In such cases power is output only from the output sections 56, 58, and the power supply device 10 is not electrically connected to onboard devices.

What is claimed is:

1. A power supply device comprising:
a main body configured mountable to a roof of a vehicle;
a tank insertion hole formed in the main body for detachable insertion of a hydrogen tank;
a fuel cell stack provided inside the main body and configured to generate electricity by being supplied with hydrogen from the hydrogen tank attached to the main body; and
an output section provided on an outer face of the main body to output power generated by the fuel cell stack.

2. The power supply device of claim 1 wherein a plurality of the tank insertion holes are formed in the main body.

3. The power supply device of claim 1, wherein the tank insertion hole opens at a front section of the main body.

4. The power supply device of claim 1, wherein the fuel cell stack is configured so as to enable power to be supplied to a battery installed to the vehicle.

5. A vehicle comprising:
a vehicle body;
a carrier provided on a roof of the vehicle body; and
the power supply device of claim 1, fixed to the carrier.
